(19) United States
(12) Patent Application Publication
(10) Pub. No.: US 2026/0320962 A1
(43) Pub. Date: Oct. 15, 2026

(54) IMAGE SEGMENTATION METHOD AND SYSTEM BASED ON DEEP LEARNING AND DIFFERENCE EXPERT MODEL, AS WELL AS DEVICE

(71) Applicant: China Agricultural University, Beijing (CN)

(72) Inventors: Yuefeng DU, Beijing (CN); Lei LIU, Beijing (CN); Guorun LI, Beijing (CN); Xiaoyu LI, Beijing (CN); Shuohua ZHANG, Beijing (CN)

(21) Appl. No.: 19/252,127

(22) Filed: Jun. 27, 2025

(30) Foreign Application Priority Data
Apr. 9, 2025 (CN) 202510442938.7

(51) Int. Cl. G06V 10/26; G06V 10/52; G06V 10/74; G06V 10/77; G06V 10/774; G06V 10/82; G06V 20/10

(52) U.S. Cl. CPC G06V 10/26; G06V 10/52; G06V 10/761; G06V 10/7715; G06V 10/774; G06V 10/82; G06V 20/188

(57) ABSTRACT

Provided are an image segmentation method and system based on deep learning and a difference expert model, as well as a device. The method includes: acquiring a target corn image; constructing an image segmentation model, and training the image segmentation model using a corn sample image training set, where the image segmentation model includes an encoder and a decoder, the encoder includes multiple coding submodules, each coding submodule includes two KVFormer units, and a KVFormer unit includes a key-value match attention mechanism subunit, the decoder includes multiple decoding submodules, each decoding submodule includes a difference mixture-of-experts model unit, and the difference mixture-of-experts model unit includes multiple expert subunits with a same structure and a subtraction operation subunit; and inputting the target corn image into a trained image segmentation model for target segmentation, where targets includes a corn kernel, a corncob and a corn husk.

### CROSS-REFERENCE TO RELATED APPLICATION

This patent application claims the benefit and priority of Chinese Patent Application No. 2025104429387 filed with the China National Intellectual Property Administration on Apr. 9, 2025, the disclosure of which is incorporated by reference herein in its entirety as part of the present application.

### TECHNICAL FIELD

The present disclosure relates to the field of image segmentation, in particular to an image segmentation method and system based on deep learning and a difference expert model, as well as a device.

### BACKGROUND

Image segmentation technology has been widely used in tillage, planting, management, harvesting and other links of agricultural production, such as impurity rate detection of the corn. However, corn images often contain corncobs and corn husks, etc., which often show significant similarity during the detection the impurity content of corn, easily causing misrecognition of image segmentation models. Secondly, the corn images contain corn kernels, corncobs, and corn husks and others in different shapes, which requires the image segmentation model to have high generalization ability. In addition, the trained image segmentation model needs to be deployed to edge computing devices in agricultural machinery and equipment for inference, while the computility of commonly used devices such as NVIDIA Jetson TX2, Raspberry Pi and Jetson Nano in agricultural field is low, making the detection frame rate of the image segmentation model low and difficult to meet the real-time requirements in agricultural production.

In conclusion, the deep learning model in the current image segmentation field still faces the problems of serious misrecognition, weak generalization ability and poor real-time performance.

### SUMMARY

An objective of the present disclosure is to provide an image segmentation method and system based on deep learning and a difference expert model, as well as device, which can improve the accuracy and efficiency of image segmentation.

To achieve the objective above, the present disclosure provides the following technical solution.

In a first aspect, the present disclosure provides an image segmentation method based on deep learning and difference expert model, including following steps:
acquiring a target corn image;
constructing an image segmentation model, and training the image segmentation model using a corn sample image training set, where the image segmentation model includes an encoder and a decoder, the encoder includes multiple coding submodules, each coding submodule includes two KVFormer units, a KVFormer unit includes a key-value match attention mechanism subunit, the decoder includes multiple decoding submodules, each decoding submodule includes a difference mixture-of-experts unit, and the difference mixture-of-experts model unit includes multiple expert subunits with a same structure and a subtraction operation subunit; and
inputting the target corn image into a trained image segmentation model for target segmentation, where targets includes a corn kernel, a corncob, and a corn husk.

In a second aspect, the present disclosure provides an image segmentation system based on deep learning and difference expert model, including:
an acquisition module, configured to acquire a target corn image;
a construction and training module, configured to construct an image segmentation model, and train the image segmentation model using a corn sample image training set, where the image segmentation model includes an encoder and a decoder, the encoder includes multiple coding submodules, each coding submodule includes two KVFormer units, a KVFormer unit includes a key-value match attention mechanism subunit, the decoder includes multiple decoding submodules, each decoding submodule includes a difference mixture-of-experts unit, and the difference mixture-of-experts model unit includes multiple expert subunits with a same structure and a subtraction operation subunit; and
a segmentation module, configured to input the target corn image into a trained image segmentation model for target segmentation, where targets includes a corn kernel, a corncob, and a corn husk.

In a third aspect, the present disclosure provides a computer device, including: a memory, a processor, and a computer program stored on the memory and capable of being operated on the processor. The processor, when executing the computer program, is configured to implement the image segmentation method based on deep learning and a difference expert model described above.

According to specific embodiments of the present disclosure, the present disclosure has the following technical effects.

The present disclosure provides an image segmentation method and system based on deep learning and a difference expert model, as well as a device. The method includes acquiring a target corn image, and inputting the target corn image into a trained image segmentation model for target segmentation, where an encoder in the image segmentation model includes multiple coding submodules, each coding submodule includes two KVFormer units, a key-value match attention mechanism subunit in a KVFormer unit can establish interdependence between segmentation windows, thereby reducing computation complexity. Based on this, the encoder can effectively reduce the computation complexity of the image segmentation model and improve recognition efficiency. A decoder in the image segmentation model includes multiple decoding submodules, each decoding submodule includes a difference mixture-of-experts model unit, and the difference mixture-of-experts model unit includes multiple expert subunits with a same structure. A feature extraction capacity of each expert subunit is uniform and balanced, so an unbalanced training effect between different expert models can be effectively avoided. In addition, a subtraction operation is adopted without introducing additional interference. Based on this, the decoder can distinguish different visual features with high similarity more accurately, and then improve the segmentation accuracy.

### BRIEF DESCRIPTION OF THE DRAWINGS

To describe the technical solutions in embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a diagram of an application environment of an image segmentation method based on deep learning and a difference expert model according to an embodiment of the present disclosure;

FIG. 2 is a flow diagram of an image segmentation method based on deep learning and a difference expert model according to an embodiment of the present disclosure;

FIG. 3 is a structural diagram of an image segmentation model according to an embodiment of the present disclosure;

FIG. 4 is a structural diagram of a coding submodule according to an embodiment of the present disclosure;

FIG. 5 is a structural diagram of a KVFormer unit in a coding submodule according to an embodiment of the present disclosure;

FIG. 6 is a structural diagram of an underlying decoding submodule according to an embodiment of the present disclosure;

FIG. 7 is a structural diagram of a difference model-of-experts (DMoE) model unit according to an embodiment of the present disclosure;

FIG. 8 is a structural diagram of a second expert subunit according to an embodiment of the present disclosure;

FIG. 9 is a structural diagram of a computer device according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

To make the objectives, features and advantages of the present disclosure more clearly, the present disclosure is further described in detail below with reference to the accompanying drawings and specific embodiments.

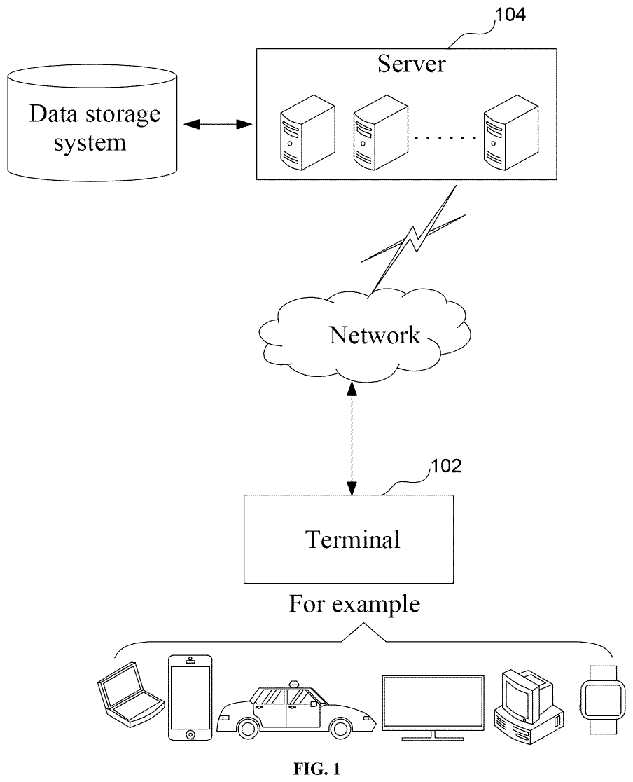

An image segmentation method based on deep learning and a difference expert model according to an embodiment of the present disclosure can be used in an application environment shown in FIG. 1. A terminal 102 communicates with a server 104 through a network. A data storage system may store data needing to be processed by the server 104. The data storage system may be separately arranged, integrated on the server 104, or placed on a cloud or other servers. The terminal 102 may transmit a target corn image to the server 104, after the server 104 receives the target corn image, for the target corn image, the server 104 is configured to input the target corn image into a trained image segmentation model for target segmentation. The server 104 may feed an obtained target segmentation result back to the terminal 102. In addition, in some embodiments, the image segmentation method based on deep learning and a difference expert model may also be separately implemented by the server 104 or the terminal 102, for example, the terminal 102 may be configured to directly segment the target corn image, or the server 104 may obtain the target corn image from the data storage system for segmentation.

The terminal 102 may be, but not limited to, various desktop computers, laptops, smart phones, tablet personal computers, Internet of Things devices and portable wearable devices. The Internet of Things device may be a smart speaker, a smart TV, a smart air conditioner, a smart vehicle-mounted device, and the like. The portable wearable device may be a smart watch, a smart bracelet, a headset, etc. The server 104 may be implemented by an independent server, or a server cluster composed of multiple servers, and may also be a cloud server.

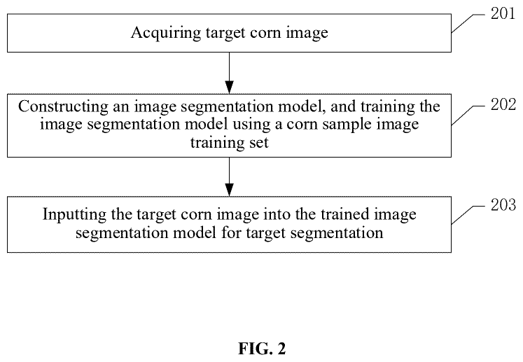

In an exemplary embodiment, as shown in FIG. 2, an image segmentation method based on deep learning and a difference expert model is provided. The method is executed by a computer device, may specifically be separately executed by a terminal, a server or other computer devices, or jointly executed by a terminal and a server. In an embodiment of the present disclosure, the application of the method to the server 104 in FIG. 1 is taken as an example, which includes the following step 201 to step 203.

In step 201, a target corn image is acquired.

In step 202, an image segmentation model is constructed, and trained by a corn sample image training set, where the image segmentation model includes an encoder and a decoder. The encoder includes multiple coding submodules, each coding submodule includes two KVFormer units, and a KVFormer unit includes a key-value match attention mechanism subunit. The decoder includes multiple decoding submodules, each decoding submodule includes a differential mixture-of-experts model unit, and the differential mixture-of-experts model unit includes multiple expert subunits with a same structure, and a subtraction operation subunit.

In step 203, the target corn image is input into a trained image segmentation model for target segmentation, where targets include a corn kernel, a corncob, and a corn husk.

By implementing the foregoing step 201 to step 203, the accuracy and efficiency of the corn image segmentation result can be improved.

In an exemplary embodiment, step 202 specifically includes step 301 to step 302.

In step 301, the target corn image is down-sampled by the encoder to obtain feature maps with different scales.

The encoder includes multiple coding submodules, each coding submodule includes two KVFormer units, and the two KVFormer units are a first KVFormer unit, and a second KVFormer unit. Each coding submodule includes a first convolutional layer, a first BatchNorm layer, the first KVFormer unit and the second KVFormer unit. In a single coding submodule, the two KVFormer units are cascaded, an output of the first KVFormer unit is used as an input of the second KVFormer unit, and an output of the second KVFormer unit is transmitted to the next coding submodule.

For an i^{-th} coding submodule, an input is Fᵢ₋₁, an output is Fᵢ, and Fᵢ₋₁ and Fᵢ are feature maps output by the i−1^{-th} coding submodule and the i^{-th} coding submodule, respectively. When i is equal to 1, F₀ is the target corn image, and a value of i is a positive integer greater than or equal to zero.

A processing procedure of the i^{-th} coding submodule specifically includes step 11 to step 14.

In step 11, a feature map Fᵢ is input into the first convolutional layer to extract detail feature information to obtain a feature map Fᵢ₁.

In step 12, the feature map Fᵢ₁ is input into the first BatchNorm layer for regularization processing to obtain a feature image Fᵢ₂.

In step 13, the feature map Fᵢ₂ is input into the first KVFormer unit to extract a high-level semantic feature to obtain a feature map Fᵢ₃.

In step 14, the feature map Fᵢ₃ is input into the second KVFormer unit to extract a high-level semantic feature to obtain a feature map Fᵢ₊₁.

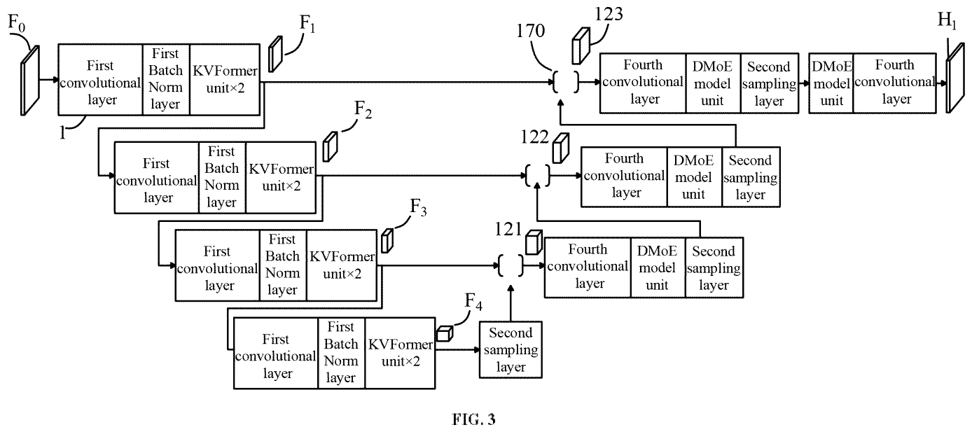

In this embodiment, the encoder includes four coding submodules, so the value of i is 4. As shown in FIG. 3, the first convolutional layer in the first coding submodule 1 is a convolutional layer with a step size of 4 and a convolution kernel of 4×4, and the first convolutional layer in each of the other three coding submodules is a convolutional layer with a step size of 2 and a convolution kernel of 2×2. The input feature map F₀ is processed by the encoder to obtain a feature map F₁, a feature map F₂, a feature map F₃, and a feature map F₄. The feature map F₁ has a size of [64, H/4, W/4], the feature map F₂ has a size of [128, H/8, W/8], the feature map F₃ has a size of [256, H/16, W/16], the feature map F₄ has a size of [512, H/32, W/32], H denotes a length of an input image, and W denotes a width of the input image.

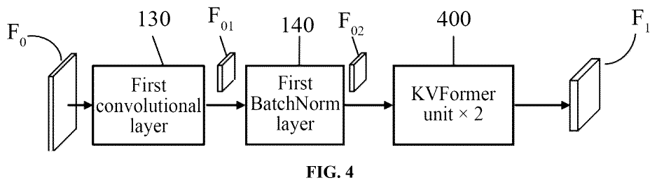

As shown in FIG. 4, taking a processing procedure of the first coding submodule as an example, a feature map F₀ input into the first coding submodule is the target corn image, which is processed by the first convolutional layer, the first BatchNorml layer and the two KVFormer units to obtain a feature map F₀₁, a feature map F₀₂, a feature map F₀₃ and a feature map F₁.

The KVFormer unit is composed of a key-value match attention (KVA) mechanism subunit and a feedforward neural network (FFN) layer in cascading. The key-value match attention mechanism subunit includes a multi-scale depth feature extraction layer, a feature concatenating layer, a second convolutional layer, a third convolutional layer, a matrix dot product layer and a second BatchNorm layer. Among them, the multi-scale depth feature extraction layer includes six deepwise separable convolutional layers with different expansion rates (expansion rates are 1, 2 . . . 6, respectively) and a convolution kernel of 3×3, and the second convolutional layer and the third convolutional layer are convolutional layers with a convolution kernel of 1×1.

The feedforward neural network layer in each KVFormer unit includes three convolutional layers with a convolution kernel of 1×1, a deepwise separable convolutional layer with a convolution kernel of 3×3, a rectified linear unit (ReLU) activation layer, and a BatchNorm layer.

Processing procedures of the first KVFormer unit and the second KVFormer unit in each coding submodule are the same. As shown in FIG. 5, the first KVFormer unit in the i^{-th} coding submodule includes a KVA subunit 410 and a feedforward neural network layer 420. Step 13 specifically includes step 131 to step 137.

In step 131, the feature map Fᵢ₂ is input into the second convolutional layer for feature extraction to obtain a V value, the input feature map Fᵢ₂ has a size of [C, H, W], where C denotes the number of channels of the input image.

In step 132, the feature map Fᵢ₂ is input into the multi-scale depth feature extraction layer 180 to extract a high-level semantic feature to obtain a multi-scale depth feature map, the multi-scale depth feature map in FIG. 5 is a feature map 411, a feature map 412, . . . , a feature map 416, and a total of six feature maps with different scales are obtained.

In step 133, the multi-scale depth feature map is input into the feature concatenating layer 170 for feature concatenating to obtain a multi-scale fused feature map 450.

In step 134, the multi-scale fused feature map 450 is input into the third convolutional layer for feature extraction to obtain an attention weight 460.

In step 135, the V value and the attention weight are input into a matrix dot product layer 470 for weighted fusion processing to obtain a weighted fused feature map.

In step 136, the weighted fused feature map is input into the second BatchNorm layer for regularization processing to obtain a regularized fused feature map 417.

In step 137, the regularized fused feature map 417 is input into the feedforward neural network layer for feature extraction to obtain the feature map Fᵢ₃.

In the training process of the image segmentation model, the multi-scale depth feature extraction layer 180 extracts features with different scales in the feature map Fᵢ₂ in an adaptive way. A self-attention (SA) mechanism in the traditional Transformer establishes interdependence between pixel points. By contrast, the KVA establishes the interdependence between windows, where a size of the window is the size of the convolution kernel in the multi-scale fused feature map.

Computation complexity Ω_{SA} of SA is defined as follows:

W_{SA}=4C²HW+2C(HW)² (1)

Computation complexity Ω_{KVA} of KVA is defined as follows:

W_{KVA}=HWC′(7C+456) (2).

By comparing formula (1) with formula (2), it is apparently found that KVA effectively reduces the computation complexity of SA and solves the problem that the computation complexity of SA is quadratic with the size of the input image, and then a demand for a computation resource is reduced.

In step 302, the feature maps with different scales are up-sampled by the decoder to obtain a high-resolution feature map. The number of the decoding submodules in the decoder is the same as that of the coding submodules in the encoder.

For a decoding submodule in an intermediate layer, an input is a feature map Fᵢ₋₁ and a feature map Hⱼ₊₁, and an output is a feature map Hⱼ; for a decoding submodule in a top layer, an input is the feature map Hⱼ₊₁, and an output is the feature map Hⱼ; for a decoding submodule in a bottom layer, an input is the feature map Fᵢ and the feature map Fᵢ₋₁, and an output is the feature map Hⱼ, where j is a serial number of a decoding submodule. There is one decoding submodule in the top layer, one decoding submodule in the bottom layer, and multiple decoding submodules in intermediate layers. A serial number of the decoding submodule in the top layer is 1, and the serial number of coding submodule increases successively from the top layer to the bottom layer.

The decoding submodule in the top layer includes a first up-sampling layer, a fourth convolutional layer, and a difference mixture-of-experts (DMoE) model unit. The first sampling layer is a 4× bilinear interpolation up-sampling layer. The decoding submodule in the intermediate layer and the decoding submodule in the bottom layer both include a second sampling layer, a matrix concatenating operation layer, a fourth convolutional layer and a DMoE model unit. The second sampling layer is a 2× bilinear interpolation up-sampling layer.

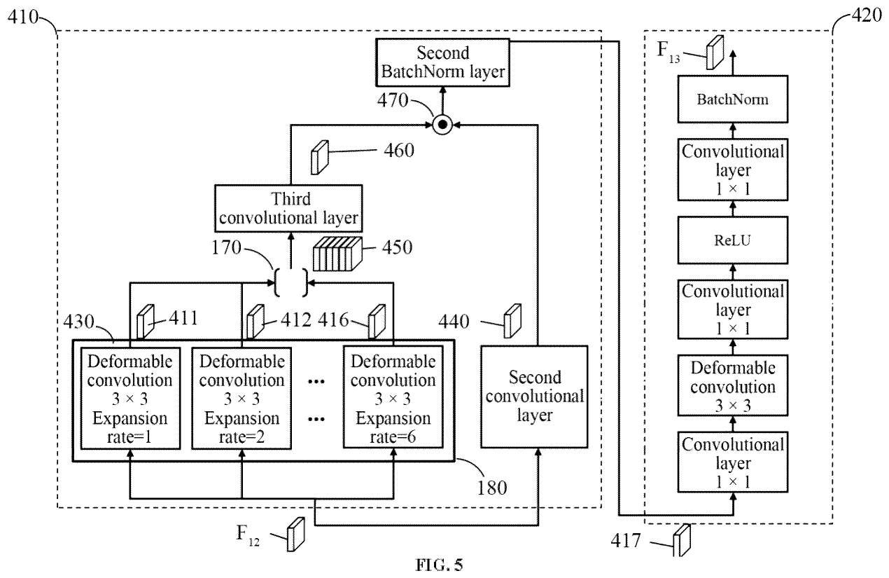

As shown in FIG. 6, a processing procedure of the decoding submodule in the bottom layer specifically includes step 21 to step 24.

In step 21, the feature map Fᵢ is input into the second sampling layer for sampling to obtain a first feature map 310.

In step 22, the first feature map 310 and the feature map Fᵢ₋₁ are input into the matrix concatenating operation layer 170 for feature concatenation to obtain a second feature map 121.

In step 23, the second feature map 121 is input into the fourth convolutional layer for feature extraction to obtain a third feature map 320.

In step 24, the third feature map 320 is input into the DMoE model unit for feature extraction to obtain the feature map Hⱼ.

As shown in FIG. 3, the processing procedure of the decoding submodule in the bottom layer is described by taking a situation that the decoder includes four decoding submodules as an example. There is one decoding submodule in the top layer, one decoding submodule in the bottom layer, and two decoding submodules in the intermediate layer. The two submodules in the intermediate layer are a first decoding submodule in the intermediate layer and a second decoding submodule of in the intermediate layer. An input of the decoding submodule in the bottom layer is the feature map F₃ and the feature map F₄, and an output of the decoding submodule in the bottom layer is a feature map H₄; an input of the first decoding submodule in the intermediate layer is the feature map F₂ and the feature map H₄, and an output of the first decoding submodule in the intermediate layer is a feature map H₃; an input of the second decoding submodule in the intermediate layer is the feature map F₁ and the feature map H₃, and an output of the second decoding submodule in the intermediate layer is a feature map H₂; and an input of the decoding submodule in the top layer is the feature map H₂, and an output of the decoding submodule in the top layer is a feature map H₁. The feature map F₄ has a size of [512, H/32, W/32], the first feature map has a size of [256, H/16, W/16], the second feature map has a size of [768, H/16, W/16], the third feature map has a size of [256, H/16, W/16], and the feature map H₁ has a size of [128, H/16, W/16]. After being processed through the decoding submodules in the intermediate layer and the decoding submodule in the top layer, the final output feature map has a size of [N, H, W], where N denotes the number of targets in a target segmentation task, and in this embodiment, N takes a value of 4, and the number of targets here includes an image background.

A processing procedure of the decoding submodules in the intermediate layer specifically includes step 31 to step 34.

In step 31, the feature map Hⱼ₊₁ is input into the second sampling layer for sampling to obtain a fourth feature map.

In step 32, the fourth feature map and the feature map Fᵢ₋₁ are input into the matrix concatenating operation layer 170 for feature concatenation to obtain a fifth feature map.

In step 33, the fifth feature map is input into the fourth convolutional layer for feature extraction to obtain a sixth feature map.

In step 34, the sixth feature map is input into the DMoE model unit for feature extraction to obtain the feature map Hⱼ.

A processing procedure of the decoding submodule in the top layer specifically includes step 41 to step 43.

In step 41, the feature map Hⱼ₊₁ is input into the first sampling layer for sampling to obtain a seventh feature map.

In step 42, the seventh feature map is input into the fourth convolutional layer for feature extraction to obtain an eighth feature map.

In step 43, the eighth feature map is input into the DMoE model unit for feature extraction to obtain the feature map Hⱼ.

In this embodiment, the DMoE model unit includes three expert subunits, which are a first expert subunit E₁, a second expert subunit E₂ and a third expert subunit E₃. Processing procedures of the DMoE model units in the decoding submodule in the top layer, the decoding submodules in the intermediate layer and the decoding submodule in the bottom layer are the same.

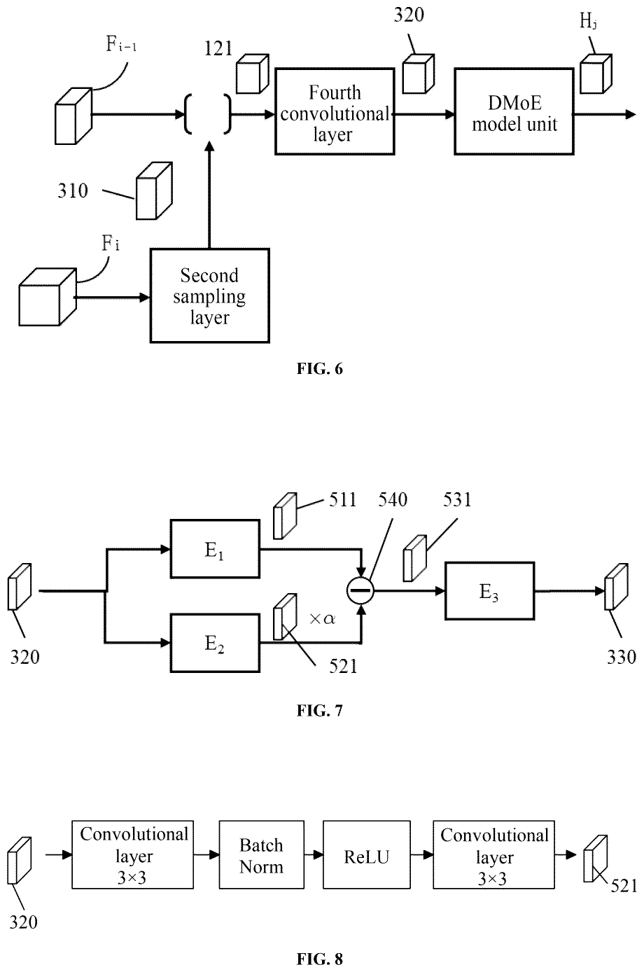

As shown in FIG. 7, a processing procedure of the DMoE model unit in the decoding submodule in the top layer specifically includes step 51 to step 55.

In step 51, the eighth feature map 320 is input into E₁ for feature extraction to obtain a first expert feature map 511.

In step 52, the eighth feature map 320 is input into E₂ for feature extraction to obtain a second expert feature map 521.

In Step 53, the second expert feature map 521 is subjected to weighted processing to obtain a second expert feature map 521 with a preset multiple, where the preset multiple in this embodiment is a.

In step 54, the second expert feature map 521 with the preset multiple and the first expert feature map 511 are input into the subtraction operation subunit 540 for subtraction operation to obtain a fused expert feature map 531.

In step 55, the fused expert feature map 531 is input into E₃ for feature extraction to obtain the feature map Hⱼ, such as the feature map 330 in FIG. 7.

When there are four decoding submodules in the decoder and four coding submodules in the encoder, the eighth feature map has a size of [256, H/16, W/16], the first expert feature map has a size of [256, H/16, W/16], the second expert feature map has a size of [256, H/16, W/16], the fused expert feature map has a size of [256, H/16, W/16], and the feature map H₁ has a size of [256, H/16, W/16].

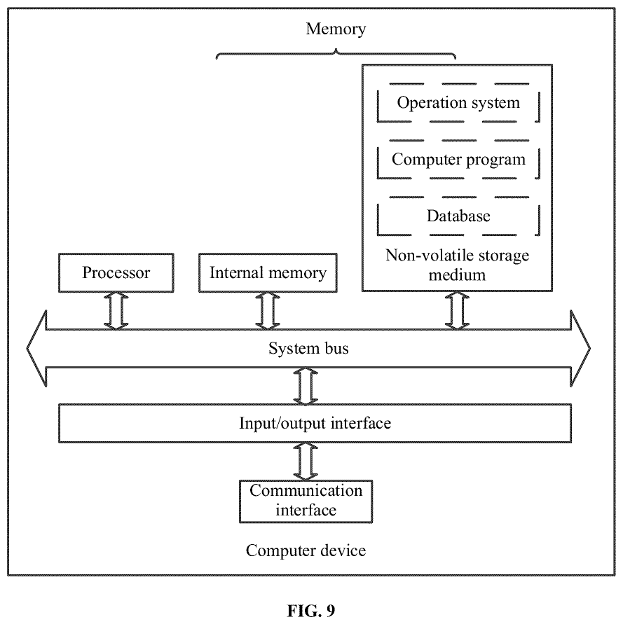

The processing on the input feature map by the three expert subunits is consistent. As shown in FIG. 8, taking the second expert subunit E₂ as an example, the eighth feature map 320 has a size of [256, H/16, W/16], the second expert feature map 521 is obtained after the input eight feature map 320 is continuously subjected to feature extraction of the convolutional layer with a convolution kernel of 3×3, a BatchNorm layer, the ReLU activation layer and a convolutional layer with a convolution kernel of 3×3, and the second expert feature map 521 has a size of [256, H/16, W/16].

In step 303, a target segmentation result is obtained based on the high-resolution feature map. Specifically, a class probability of each pixel is calculated by Softmax, and a final target segmentation result is output.

The application of the image segmentation model in the present disclosure is Scenario 1, and the image segmentation model may also be applied to other scenarios. For example, Scenario 2: the trained image segmentation model is deployed to an edge computing device of a field weeding robot to identify and classify weeds, with the target being corn plants; Scenario 3: the trained image segmentation model is deployed to an edge computing device of a spraying machine to detect pests and diseases, with the target being the leaf disease region.

A training process of the image segmentation model in the present disclosure is as follows. A training framework of the image segmentation model is Pytorch. In a forward propagation phase of the image segmentation model, high-level semantic features are extracted from an input corn sample image through a down-sampling operation by multiple successive coding sub-modules in the encoder, and low-resolution feature maps with different sizes are generated. Then, spatial information of features is recovered by the decoder through the up-sampling operation and skip connection of multiple successive decoding submodules, and a high-resolution feature map is generated. Finally, the class probability of each pixel is calculated by Softmax, and the final target segmentation result is output.

In a backpropagation stage, gradients of parameters in each layer are calculated by using an error backpropagation algorithm. An optimizer Adam is configured to update a network weight according to the gradient information, where an initial learning rate is 10e-3, a learning rate policy is linear, a batch size is 8, the number of training rounds is 120, and a dropout rate is 0.1. The image segmentation model takes the cross entropy loss function L as a loss value between a calculated prediction result and a label, and L is defined as formula (3). In addition, the image segmentation model uses the BatchNorm layer to accelerate the training and improve generalization ability.

$$L = \frac{1}{N} {å}_{i} {L}_{i} = \frac{1}{N} {å}_{i} - [ {y}_{i} log ( {p}_{i} ) + ( 1 - {y}_{i} ) log ( 1 - {p}_{i} ) ] \qquad ( 3 )$$

where i indicates an i^{-th} corn sample image, N is a total number of corn sample images in the corn sample image training set, Lᵢ is a loss value of the i^{-th} corn sample image, yᵢ is a true value, and pᵢ is a predicted value.

In the training process, the model performance is evaluated to prevent over-fitting. Pixel accuracy (PA) and mean intersection over union (IoU) (MIoU) are used as evaluation indexes. PA is configured to measure a correct classification proportion of all pixels, and is defined as formula (4). MIoU is configured to calculate IoU mean of each class to measure overlapping degree between the predicted value and the actual value, and is defined as formula (5).

$$PA = \frac{TP + TN}{TP + TN + FP + FN} \qquad ( 4 )$$

$$MIoU = {\sum }_{i = 1}^{n} \frac{TP}{TP + FP + FN} \qquad ( 5 )$$

Finally, after reaching the number of training iterations, the image segmentation model completes training, or in the training process of the image segmentation model, the training is terminated in advance when the loss value stops decreasing. The image segmentation model is finally evaluated on a test set after loading an optimal training weight to ensure the generalization ability.

In Scenario 2, a corn plant graphic sample set is used, and in Scenario 3, the image segmentation model is trained by a pest and disease image sample set. The loss values of the trained image segmentation model in the three scenario training sets are stable at around 0.07, 0.03 and 0.04, respectively. During the testing, the image segmentation model achieves 95.2% in PA and 91.6% in MIoU in the test set of Scenario 1, the image segmentation model achieves 97.3% in PA and 94.7% in MIoU in the test set of Scenario 2, and PA in the test set of Scenario 3 reaches 96.8% and 93.8%, respectively. The image segmentation model has a good segmentation effect for different targets and shows excellent generalization ability. In conclusion, the image segmentation model provided in the present disclosure shows strong segmentation performance and application potential in an agricultural scene segmentation task.

Based on the same inventive concept, an embodiment of the present disclosure also provides an image segmentation system based on deep learning and a difference expert model for implementing the foregoing image segmentation method based on deep learning and a difference expert model. An implementation solution for solving the problem provided by an apparatus is similar to that described in the foregoing method, so the specific limitation of one or more embodiments of the image segmentation system based on deep learning and a difference expert model provided below can be found in the above limitation of the image segmentation method based on deep learning and a difference expert model, and will not be repeated here.

In an exemplary embodiment, the present disclosure provides an image segmentation system based on deep learning and a difference expert model, including:
an acquisition module, configured to acquire a target corn image;
a construction and training module, configured to construct and train an image segmentation model, where the image segmentation model includes an encoder and a decoder, the encoder includes multiple coding submodules, each coding submodule includes two KVFormer units, the KVFormer unit includes a key-value match attention mechanism subunit, the decoder includes multiple decoding submodules, each decoding submodule includes a difference mixture-of-experts model unit, and the difference mixture-of-experts model unit includes multiple expert subunits with a same structure, a subtraction operation subunit and weight coefficient; the image segmentation model is trained using a corn sample image training set; and
a segmentation module, configured to input the target corn image into a trained image segmentation model for target segmentation, where the targets includes a corn kernel, a corncob, and a corn husk.

In an exemplary embodiment, a computer device is provided, which may be a server or a terminal, with an internal structural diagram shown in FIG. 9. The computer device includes a processor, a memory, an input/output interface (short for I/O), and a communication interface. The processor, the memory and the input/output interface are connected through a system bus, and the communication interface is connected to the system bus through the input/output interface. The processor of the computer device is used for providing computing and control capabilities. The memory of the computer device includes a non-volatile storage medium, and an internal memory. An operation system, a computer program and a database are stored in the non-volatile storage medium. The internal memory provides an environment for the running of the operation system and the computer program in the non-volatile storage medium. The database of the computer device is configured to store the target corn image. The input/output interface of the computer device is configured to exchange information between the processor and an external device. The communication interface of the computer device is configured to communicate with an external terminal through a network. The computer program, when executed by the processor, is configured to implement an image segmentation method based on deep learning and a difference expert model.

Those skilled in the part may understand that the structure shown in FIG. 9 is only a block diagram of a part of the structure related to the solution of the present disclosure, and does not constitute a limitation on the computer device to which the solution of the present disclosure is applied. The specific computer device may include more or less components than those shown in the figure, or combine some components, or have different component arrangements.

In an exemplary embodiment, a computer device is further provided, including: a memory and a processor. A computer program is stored on the memory, and the processor, when executing the computer program, is configured to implement steps in the method embodiments described above.

It should be noted that the user information (including, but not limited to, user equipment information, user personal information, etc.) and data (including, but not limited to, data for analysis, stored data, displayed data, etc.) involved in the present disclosure are all information and data authorized by the user or fully authorized by all parties, and the collection, use and processing of relevant data need to comply with relevant regulations.

Those skilled in the art should understand that all or part of the processes in method for implementing the foregoing embodiments can be completed by instructing related hardware through a computer program, the computer program can be stored in a non-volatile computer-readable storage medium, and when executed, the computer program may include the processes of the embodiments of the foregoing method. Any reference to the memory, the database or other media used in the embodiments provided in the present disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM), or an external cache memory. By way of illustration than limitation, RAM may be in various forms, such as a static random access memory (SRAM) or a dynamic random access memory (DRAM).

The database involved in the embodiments provided by the present disclosure may include at least one of a relational database and a non-relational database. The non-relational database may include, but is not limited to, a distributed database based on a block chain. The processor involved in each embodiment provided by the present disclosure may be, but is not limited to, a general processor, a central processing unit, a graphics processing unit, a digital signal processor, a programmable logic, a data processing logic based on quantum computing, etc., without limitation.

Various technical features of the foregoing embodiments can be combined at will. To make the description concise, not all possible combinations of the technical features in the above embodiments are described. However, it should be considered that these combinations of technical features fall within the scope recorded in this specification provided that these combinations of technical features do not have any conflict.

Specific examples are used herein for illustration of the principles and embodiments of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. An image segmentation method based on deep learning and a difference expert model, comprising:
acquiring a target corn image;
constructing an image segmentation model, and training the image segmentation model using a corn sample image training set, wherein the image segmentation model comprises an encoder and a decoder, the encoder comprises a plurality of coding submodules, each coding submodule comprises two KVFormer units, a KVFormer unit comprises a key-value match attention mechanism subunit, the decoder comprises a plurality of decoding submodules, each decoding submodule comprises a difference mixture-of-experts model unit, and the difference mixture-of-experts model unit comprises a plurality of expert subunits with a same structure and a subtraction operation subunit; and
inputting the target corn image into a trained image segmentation model for target segmentation, wherein targets comprises a corn kernel, a corncob, and a corn husk.

2. The image segmentation method based on the deep learning and the difference expert model according to claim 1, wherein the inputting the target corn image into a trained image segmentation model for target segmentation comprises:
performing a down-sampling operation on the target corn image by the encoder to obtain feature maps with different scales;
performing an up-sampling operation on the feature maps with different scales by the decoder to obtain an up-sampled feature map; and
obtaining a target segmentation result based on the up-sampled feature map.

3. The image segmentation method based on the deep learning and the difference expert model according to claim 2, wherein for an i^{-th} coding submodule, an input is Fᵢ₋₁, an output is Fᵢ, and Fᵢ₋₁ and Fᵢ are feature maps output by the (i−1)^{-th} coding submodule and the i^{-th} coding submodule, respectively; and when i is equal to 1, F₀ is the target corn image.

4. The image segmentation method based on the deep learning and the difference expert model according to claim 3, wherein the two KVFormer units are a first KVFormer unit and a second KVFormer unit; each coding submodule comprises a first convolutional layer, a first BatchNorm layer, the first KVFormer unit and the second KVFormer unit;
a processing procedure of the i^{-th} coding submodule comprises:
inputting a feature map Fᵢ into the first convolutional layer to extract detail feature information to obtain a feature map Fᵢ₁;
inputting the feature map Fᵢ₁ into the first BatchNorm layer for regularization processing to obtain a feature image Fᵢ₂;
inputting the feature map Fᵢ₂ into the first KVFormer unit to extract a high-level semantic feature to obtain a feature map Fᵢ₃; and
inputting the feature map Fᵢ₃ into the second KVFormer unit to extract a high-level semantic feature to obtain a feature map Fᵢ+1.

5. The image segmentation method based on the deep learning and the difference expert model according to claim 4, wherein the KVFormer unit further comprises a feedforward neural network layer;
the key-value match attention mechanism subunit comprises a multi-scale depth feature extraction layer, a feature concatenating layer, a second convolutional layer, a third convolutional layer, a matrix dot product layer, and a second BatchNorm layer;
processing procedures of the first KVFormer unit and the second KVFormer unit are same; for the first KVFormer unit, the inputting the feature map Fᵢ₂ into the first KVFormer unit to extract a high-level semantic feature to obtain a feature map Fᵢ₃ comprises:
inputting the feature map Fᵢ₂ into the second convolutional layer for feature extraction to obtain a V value;
inputting the feature map Fᵢ₂ into the multi-scale depth feature extraction layer to extract a high-level semantic feature to obtain a multi-scale depth feature map;
inputting the multi-scale depth feature map into the feature concatenating layer for feature concatenating to obtain a multi-scale fused feature map;
inputting the multi-scale fused feature map into the third convolutional layer for feature extraction to obtain an attention weight;
inputting the V value and the attention weight into the matrix dot product layer for weighted fusion processing to obtain a weighted fused feature map;
inputting the weighted fused feature map into the second BatchNorm layer for regularization processing to obtain a regularized fused feature map; and
inputting the regularized fused feature map into the feedforward neural network layer for feature extraction to obtain the feature map Fᵢ₃.

6. The image segmentation method based on the deep learning and the difference expert model according to claim 5, wherein a number of the decoding submodules is same as that of the coding submodules;
for a decoding submodule in an intermediate layer, an input is a feature map Fᵢ₋₁ and a feature map Hⱼ₊₁, and an output is a feature map Hⱼ; for a decoding submodule in a top layer, an input is the feature map Hⱼ₊₁, and an output is the feature map Hⱼ; for a decoding submodule in a bottom layer, an input is the feature map Fᵢ and the feature map Fᵢ₋₁, and an output is the feature map Hⱼ, wherein j is a serial number of the decoding submodule; one decoding submodule is disposed in the top layer, one decoding submodule is disposed in the bottom layer and a plurality of decoding submodules are disposed in the intermediate layer.

7. The image segmentation method based on the deep learning and the difference expert model according to claim 6, wherein the decoding submodule in the top layer comprises an first up-sampling layer, a fourth convolutional layer and a difference mixture-of-experts model unit; each of the decoding submodules in the intermediate layer and the decoding submodule in the bottom layer comprises a second sampling layer, a matrix concatenating layer, a fourth convolutional layer, and a difference mixture-of-experts model unit;
a processing procedure of the decoding submodule in the bottom layer comprises:
inputting the feature map Fᵢ into the second sampling layer for sampling to obtain a first feature map;
inputting the first feature map and the feature map Fᵢ₋₁ into the matrix concatenating layer for feature concatenation to obtain a second feature map;
inputting the second feature map into the fourth convolutional layer for feature extraction to obtain a third feature map; and
inputting the third feature map into the different mixture-of-experts model unit for feature extraction to obtain the feature map Hⱼ;
a processing procedure of the decoding submodule in the intermediate layer comprises:
inputting the feature map Hⱼ₊₁ into the second sampling layer for sampling to obtain a fourth feature map;
inputting the fourth feature map and the feature map Fᵢ₋₁ into a matrix concatenating layer for feature concatenation to obtain a fifth feature map;
inputting the fifth feature map into the fourth convolutional layer for feature extraction to obtain a sixth feature map;
inputting the sixth feature map into the different mixture-of-experts model unit for feature extraction to obtain the feature map Hⱼ; and
a processing procedure of the decoding submodule in the top layer comprises:
inputting the feature map Hⱼ₊₁ into the first sampling layer for sampling to obtain a seventh feature map;
inputting the seventh feature map into the fourth convolutional layer for feature extraction to obtain an eighth feature map; and
inputting the eighth feature map into the different mixture-of-experts model unit for feature extraction to obtain the feature map Hⱼ.

8. The image segmentation method based on the deep learning and the difference expert model according to claim 7, wherein the difference mixture-of-experts model unit comprises three expert subunits, processing procedures of the difference mixture-of-experts model units in the decoding submodule of the top layer, the decoding submodule of the intermediate layer and the decoding submodule of the bottom layer are same;
a processing procedure of the difference mixture-of-experts model unit in the decoding submodule of the top layer, comprises:
inputting the eighth feature map into a first expert subunit for feature extraction to obtain a first expert feature map;
inputting the eighth feature map into a second expert subunit for feature extraction to obtain a second expert feature map;
weighting the second expert feature map to obtain a second expert feature map with a predetermined multiple;
inputting the second expert feature map with the predetermined multiple and the first expert feature map into the subtraction operation subunit for subtraction to obtain a fused expert feature map; and
inputting the fused expert feature map into a third expert subunit for feature extraction to obtain the feature map Hⱼ.

9. An image segmentation system based on deep learning and a difference expert model, comprising:
an acquisition module, configured to acquire a target corn image;
a construction and training module, configured to construct an image segmentation model, and train the image segmentation model using a corn sample image training set, wherein the image segmentation model comprises an encoder and a decoder, the encoder comprises a plurality of coding submodules, each coding submodule comprises two KVFormer units, a KVFormer unit comprises a key-value match attention mechanism subunit, the decoder comprises a plurality of decoding submodules, each decoding submodule comprises a difference mixture-of-experts model unit, and the difference mixture-of-experts model unit comprises a plurality of expert subunits with a same structure and a subtraction operation subunit; and
a segmentation module, configured to input the target corn image into a trained image segmentation model for target segmentation, wherein targets comprises a corn kernel, a corncob, and a corn husk.

10. A computer device, comprising: a memory, a processor, and a computer program stored on the memory and capable of being operated on the processor, wherein the processor, when executing the computer program, is configured to implement the image segmentation method based on the deep learning and the difference expert model according to claim 1.

11. The computer device according to claim 10, wherein the inputting the target corn image into a trained image segmentation model for target segmentation comprises:
performing a down-sampling operation on the target corn image by the encoder to obtain feature maps with different scales;
performing an up-sampling operation on the feature maps with different scales by the decoder to obtain an up-sampled feature map; and
obtaining a target segmentation result based on the up-sampled feature map.

12. The computer device according to claim 11, wherein for an i^{-th} coding submodule, an input is Fᵢ₋₁, an output is Fᵢ, and Fᵢ₋₁ and Fᵢ are feature maps output by the (i−1)^{-th} coding submodule and the i^{-th} coding submodule, respectively; and when i is equal to 1, F₀ is the target corn image.

13. The computer device according to claim 12, wherein the two KVFormer units are a first KVFormer unit and a second KVFormer unit; each coding submodule comprises a first convolutional layer, a first BatchNorm layer, the first KVFormer unit and the second KVFormer unit;
a processing procedure of the i^{-th} coding submodule comprises:
inputting a feature map Fᵢ into the first convolutional layer to extract detail feature information to obtain a feature map Fᵢ₁;
inputting the feature map Fᵢ₁ into the first BatchNorm layer for regularization processing to obtain a feature image Fᵢ₂;
inputting the feature map Fᵢ₂ into the first KVFormer unit to extract a high-level semantic feature to obtain a feature map Fᵢ₃; and
inputting the feature map Fis into the second KVFormer unit to extract a high-level semantic feature to obtain a feature map Fᵢ+1.

14. The computer device according to claim 13, wherein the KVFormer unit further comprises a feedforward neural network layer;
the key-value match attention mechanism subunit comprises a multi-scale depth feature extraction layer, a feature concatenating layer, a second convolutional layer, a third convolutional layer, a matrix dot product layer, and a second BatchNorm layer;
processing procedures of the first KVFormer unit and the second KVFormer unit are same; for the first KVFormer unit, the inputting the feature map Fᵢ₂ into the first KVFormer unit to extract a high-level semantic feature to obtain a feature map Fᵢ₃ comprises:
inputting the feature map Fᵢ₂ into the second convolutional layer for feature extraction to obtain a V value;
inputting the feature map Fᵢ₂ into the multi-scale depth feature extraction layer to extract a high-level semantic feature to obtain a multi-scale depth feature map;
inputting the multi-scale depth feature map into the feature concatenating layer for feature concatenating to obtain a multi-scale fused feature map;
inputting the multi-scale fused feature map into the third convolutional layer for feature extraction to obtain an attention weight;
inputting the V value and the attention weight into the matrix dot product layer for weighted fusion processing to obtain a weighted fused feature map;
inputting the weighted fused feature map into the second BatchNorm layer for regularization processing to obtain a regularized fused feature map; and
inputting the regularized fused feature map into the feedforward neural network layer for feature extraction to obtain the feature map Fᵢ₃.

15. The computer device according to claim 14, wherein a number of the decoding submodules is same as that of the coding submodules;
for a decoding submodule in an intermediate layer, an input is a feature map Fᵢ₋₁ and a feature map Hⱼ₊₁, and an output is a feature map Hⱼ; for a decoding submodule in a top layer, an input is the feature map Hⱼ₊₁, and an output is the feature map Hⱼ; for a decoding submodule in a bottom layer, an input is the feature map Fᵢ and the feature map Fᵢ₋₁, and an output is the feature map Hⱼ, wherein j is a serial number of the decoding submodule; one decoding submodule is disposed in the top layer, one decoding submodule is disposed in the bottom layer and a plurality of decoding submodules are disposed in the intermediate layer.

16. The computer device according to claim 15, wherein the decoding submodule in the top layer comprises an first up-sampling layer, a fourth convolutional layer and a difference mixture-of-experts model unit; each of the decoding submodules in the intermediate layer and the decoding submodule in the bottom layer comprises a second sampling layer, a matrix concatenating layer, a fourth convolutional layer, and a difference mixture-of-experts model unit;
a processing procedure of the decoding submodule in the bottom layer comprises:
inputting the feature map Fᵢ into the second sampling layer for sampling to obtain a first feature map;
inputting the first feature map and the feature map Fᵢ₋₁ into the matrix concatenating layer for feature concatenation to obtain a second feature map;
inputting the second feature map into the fourth convolutional layer for feature extraction to obtain a third feature map; and
inputting the third feature map into the different mixture-of-experts model unit for feature extraction to obtain the feature map Hⱼ;
a processing procedure of the decoding submodule in the intermediate layer comprises:
inputting the feature map Hⱼ₊₁ into the second sampling layer for sampling to obtain a fourth feature map;
inputting the fourth feature map and the feature map Fᵢ₋₁ into a matrix concatenating layer for feature concatenation to obtain a fifth feature map;
inputting the fifth feature map into the fourth convolutional layer for feature extraction to obtain a sixth feature map;
inputting the sixth feature map into the different mixture-of-experts model unit for feature extraction to obtain the feature map Hⱼ; and
a processing procedure of the decoding submodule in the top layer comprises:
inputting the feature map Hⱼ₊₁ into the first sampling layer for sampling to obtain a seventh feature map;
inputting the seventh feature map into the fourth convolutional layer for feature extraction to obtain an eighth feature map; and
inputting the eighth feature map into the different mixture-of-experts model unit for feature extraction to obtain the feature map Hⱼ.

17. The computer device according to claim 16, wherein the difference mixture-of-experts model unit comprises three expert subunits, processing procedures of the difference mixture-of-experts model units in the decoding submodule of the top layer, the decoding submodule of the intermediate layer and the decoding submodule of the bottom layer are same;
a processing procedure of the difference mixture-of-experts model unit in the decoding submodule of the top layer, comprises:
inputting the eighth feature map into a first expert subunit for feature extraction to obtain a first expert feature map;
inputting the eighth feature map into a second expert subunit for feature extraction to obtain a second expert feature map;
weighting the second expert feature map to obtain a second expert feature map with a predetermined multiple;
inputting the second expert feature map with the predetermined multiple and the first expert feature map into the subtraction operation subunit for subtraction to obtain a fused expert feature map; and
inputting the fused expert feature map into a third expert subunit for feature extraction to obtain the feature map Hⱼ.
